(19) United States
(12) Patent Application Publication
(10) Pub. No.: US 2016/0345564 A1
(43) Pub. Date: Dec. 1, 2016

(54) Fishing Bobbers

(71) Applicant: Galahad Charters, LLC, Cape Coral, FL (US)

(72) Inventors: Dominic T. Nicosia, Cape Coral, FL (US); Christopher J. Luizzi, Fort Myers, FL (US); Brian D. Luizzi, Cape Coral, FL (US); Kevin Pratt, Cape Coral, FL (US)

(73) Assignee: Galahad Charters, LLC, Cape Coral, FL (US)

(21) Appl. No.: 15/170,236

(22) Filed: Jun. 1, 2016

Related U.S. Application Data
(60) Provisional application No. 62/169,329, filed on Jun. 1, 2015.

(51) Int. Cl. A01K 93/00; A01K 97/00

(52) U.S. Cl. CPC A01K 93/00; A01K 97/00

(57) ABSTRACT

A fishing bobber can include a float body having an internal cavity with a weight and a rattler. The float body can have a concave top that expels out displaced water to create a splash. The fishing bobber may include a stem extending through the float body and terminating at a first end and a second end. The first end may include a first biased member and the second end may include a second biased member. A line securing rod with opposing hooks extending coaxially with the stem and beyond the first biased member and the second biased member can also be provided. The fishing bobber may also include opposing stem caps, where each stem cap can have with a central bore through which an opposing hook of the line securing rod extends. The float body may have a channel for receiving fishing line.

### CROSS REFERENCE TO RELATED-APPLICATIONS

This application claims priority to U.S. Provisional Patent Application Ser. No. 62/169,329, filed Jun. 1, 2015, which is hereby incorporated by reference in its entirety.

### FIELD OF THE INVENTION

The present application relates to fishing floatation devices, and more particularly, to adjustable fishing bobbers.

### BACKGROUND

A fishing bobber or float is a type of angling equipment that is commonly used by a fisherman when fishing. Notably, a fishing bobber can serve several purposes. As a first example, based on the buoyancy characteristics of a fishing bobber, the fishing bobber may be utilized to suspend a bait at a predetermined depth in a body of water. For example, if a fisherman is fishing in a lake that is twenty feet deep and the fisherman needs to get the bait near the bottom of the lake, the fisherman may attach the fishing bobber at position on the fishing line so that bait is suspended at least seventeen feet under the fishing bobber while the fisherman is fishing. Additionally, by having the bait suspended seventeen feet under the fishing bobber, the fisherman can be quite confident that the fish hook or the bait attached to the fish hook does not get snagged on rocks or other debris that may be located at the bottom of the lake. As another example, a fishing bobber can serve as a signaling mechanism that can indicate when a fish is attacking, hitting, or biting the bait. When a fish begins to attack or bite the bait that is suspended using the fishing bobber, the fishing bobber may be pulled slightly down under the water. As the fish continues to attack and bite the bait, the fishing bobber may be pulled down under the surface of the water repeatedly, signaling to the fisherman that the fish is hitting the bait, but not yet hooked. Once hooked, the fish may pull the entire fishing bobber under the water, signaling to the fisherman that the fish is hooked.

Fishing bobbers can come in many different types, sizes, shapes, and materials. For example, such fishing bobbers may include, but are not limited to, Avon floats, bubble floats, Dink floats, poppers, quills, stick floats, self-cocking floats, wagglers, among other types of bobbers. Additionally, fishing bobbers may be made of balsa wood, plastics, foam materials, reeds, quills, cork material, or other materials that may be suitable for a floatation device. Although current types of fishing bobbers provide many useful benefits to fishermen, such as providing the above-described signaling function to a fisherman, fishermen desire additional functions for fishing bobbers.

### SUMMARY

The disclosed embodiments of fishing bobbers provide advantages over prior art bobbers. One such advantage provided by the fishing bobber is the ability to quickly and easily change the position of the bobber along the fishing line without cutting the line or tying any knots, which in turn, changes the depth of the bait. This disclosure also provides a weighted bobber that aids in casting, while also maintaining adequate buoyancy characteristics. Still further, the fishing bobbers disclosed herewith provide functionality beyond merely providing a means for floatation. The fishing bobber may be utilized to attract fish by the inclusion of rattlers within the float body that make noise and vibrations that attract fish. Additionally, the shape of the float body of the fishing bobber may also be utilized to attract fish. In certain embodiments, the float body of the fishing bobber may be frusto-conical with the smaller end, or the bottom, pointed downward in the water and the larger end, or the top, above the water. In certain embodiments, the top of the float body may be concave with a recessed flat surface. When fishing, water may be displaced onto the concave top of the frusto-conical float body and may then be expelled, thrown, or splashed out. Such a splash may be utilized to attract the types of fish targeted by the fisherman.

In one embodiment, the fishing bobber can include a float body having an internal cavity with one or more weights and one or more rattlers. The float body may have a concave top that expels out displaced water to create a splash. The fishing bobber may also include a stem extending through the float body and terminating at a first end and a second end. The first end may have a first biased member and the second end may have a second biased member. A line securing rod with opposing hooks extending coaxially with the stem and beyond the first biased member and the second biased member may also be provided. The fishing bobber may also include opposing stem caps, where each stem cap may have a central bore through which an opposing hook of the line securing rod extends. Also, in certain embodiments, the opposing stem caps and the float body may each have a channel for receiving fishing line, and the channel of the opposing stem caps and the channel of the float body may be linearly aligned.

In another embodiment, the float body of the fishing bobber may be frusto-conical. Also, the float body may be inverted frusto-conical. Still further, the first biased member and second biased member may be springs. The first biased member and second biased member may be individually seated between the stem and the opposing stem caps.

In another embodiment, the weights utilized with the fishing bobber may have a shape that matches the internal cavity shape of the float body. For instance, the weights may have a shape corresponding to an incomplete annulus. Also, the opposing hooks may be releasably clamped to fishing line at each of the opposing stem caps, such that the position of the bobber along the fishing line may be changed without cutting the line or tying knots.

### BRIEF DESCRIPTION OF THE DRAWINGS

FIG. 1 is a perspective view of a fishing bobber according to an embodiment of the present disclosure.

FIG. 2 is an exploded view of the fishing bobber of FIG. 1.

FIG. 3 is a cross sectional view of the fishing bobber of FIG. 1 taken along line lines A-A.

FIG. 4A is a view of a portion of the fishing bobber of FIG. 1.

FIG. 4B is a view of FIG. 4A with certain portions of the fishing bobber being transparent.

FIG. 5 is a view of a portion of the fishing bobber of FIG. 1 with the internal structures being shown as transparent.

FIG. 6 is a close-up perspective view of a top portion of the fishing bobber of FIG. 1.

FIG. 7 is a perspective view of a fishing bobber according to another embodiment of the present disclosure.

FIG. 8 is an exploded view of the fishing bobber of FIG. 7.

FIG. 9A is a perspective view of the fishing bobber of FIG. 7.

FIG. 9B is a perspective view illustrating various internal components of the fishing bobber of FIG. 7.

FIG. 10A is a perspective view of the fishing bobber of FIG. 7.

FIG. 10B is a cross-sectional view of fishing bobber shown in FIG. 10A.

FIG. 11A is a side view of a stem cap of the fishing bobber of FIG. 7.

FIG. 11B is an angled bottom view of the stem cap of FIG. 11A.

FIG. 12 is a perspective view of a float body and a bottom cap of the float body of the fishing bobber of FIG. 7.

FIG. 13 illustrates perspective views of a float body and a top cap of the float body of the fishing bobber of FIG. 7.

FIG. 14A is a view of the stem/shaft utilized in the fishing bobber of FIG. 7.

FIG. 14B is a cross-sectional view of the stem/shaft of FIG. 14A.

FIG. 15A is a cross-sectional view of the fishing bobber of FIG. 7, which illustrates the hooks of the line securing rod of the fishing bobber in an exposed state.

FIG. 15B is a cross-sectional view of a portion of the fishing bobber of FIG. 7.

FIG. 15C is a close-up view of a portion of the fishing bobber of FIG. 7 that illustrates various internal components of the fishing bobber.

FIG. 16A is a cross-sectional view of the fishing bobber of FIG. 7, which illustrates the hooks of the line securing rod of the fishing bobber in retracted state.

FIG. 16B a cross-sectional view of a portion of the fishing bobber of FIG. 7.

FIG. 16C a cross-sectional view of a portion of the fishing bobber of FIG. 7 that illustrates various internal components of the fishing bobber.

FIG. 17 is a perspective view of the fishing bobber of FIG. 7, which illustrates fishing line secured to the fishing bobber and various internal components of the fishing bobber.

FIG. 18 is a perspective view of the fishing bobber of FIG. 7, which illustrates fishing line secured to the fishing bobber.

FIG. 19 is a side view of the fishing bobber of FIG. 7, which illustrates fishing line secured to the fishing bobber.

FIG. 20 is a side view of the fishing bobber of FIG. 7, which illustrates fishing line secured to the fishing bobber and various internal components of the fishing bobber.

FIG. 21 is a cross-sectional view of the fishing bobber of FIG. 7, which illustrates fishing line secured to the fishing bobber and various internal components of the fishing bobber.

FIG. 22 is a top view of the fishing bobber of FIG. 7, which illustrates fishing line secured to the fishing bobber.

FIG. 23 is an angled top view of the fishing bobber of FIG. 7, which illustrates fishing line secured to the fishing bobber.

### DETAILED DESCRIPTION OF THE INVENTION

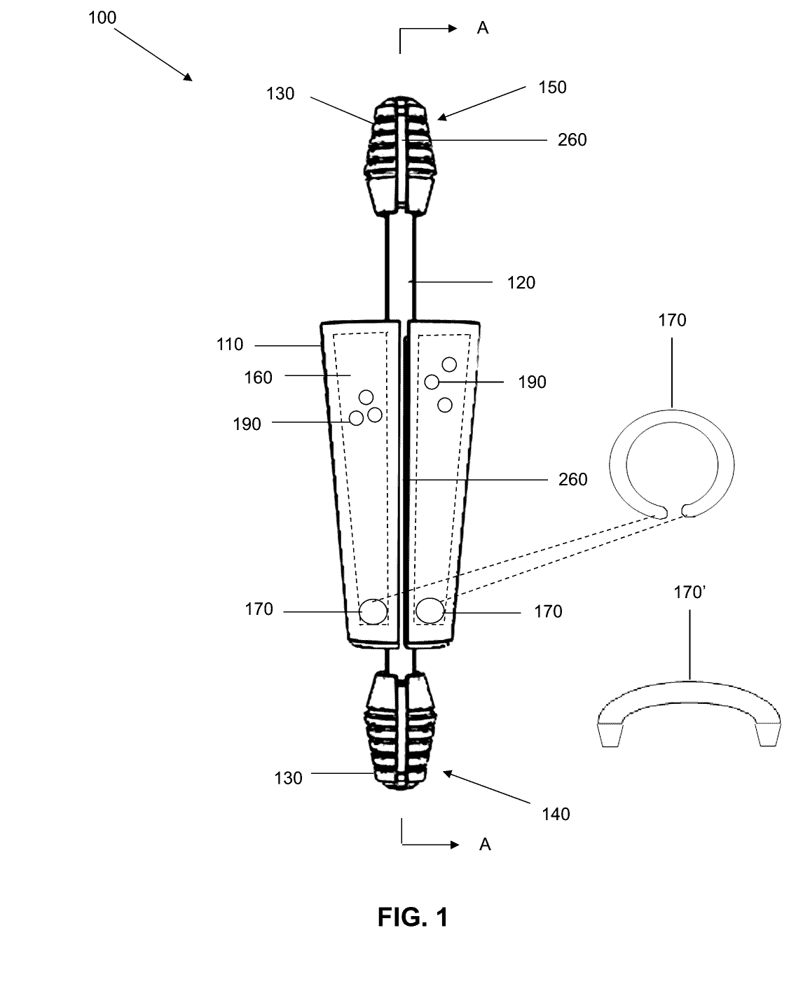

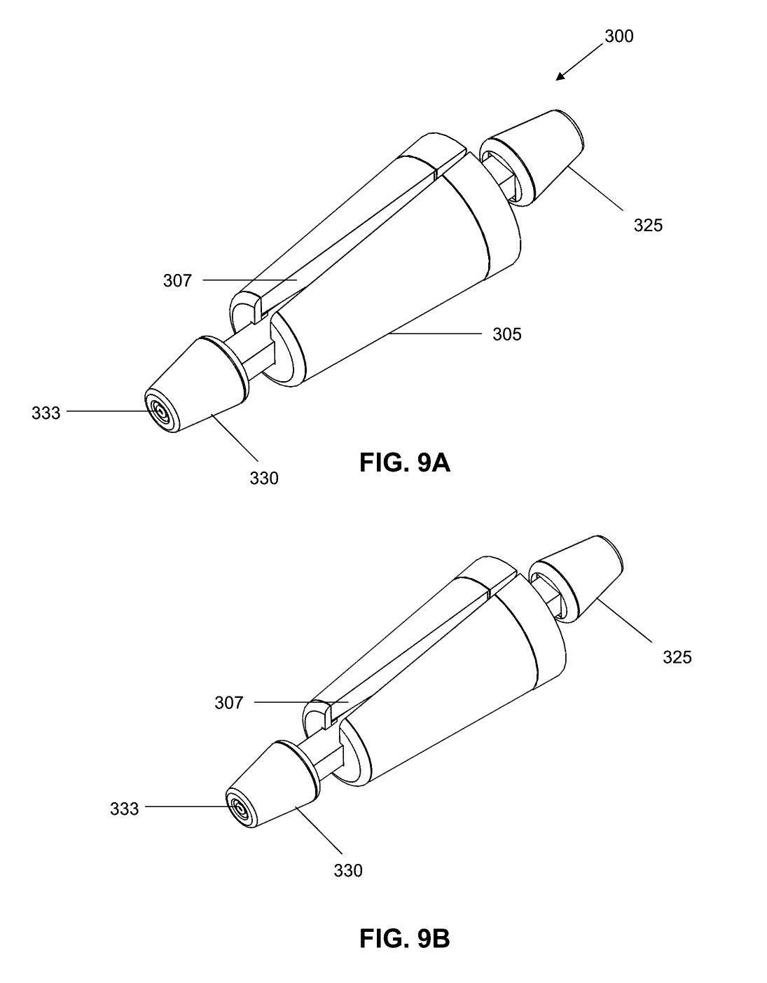

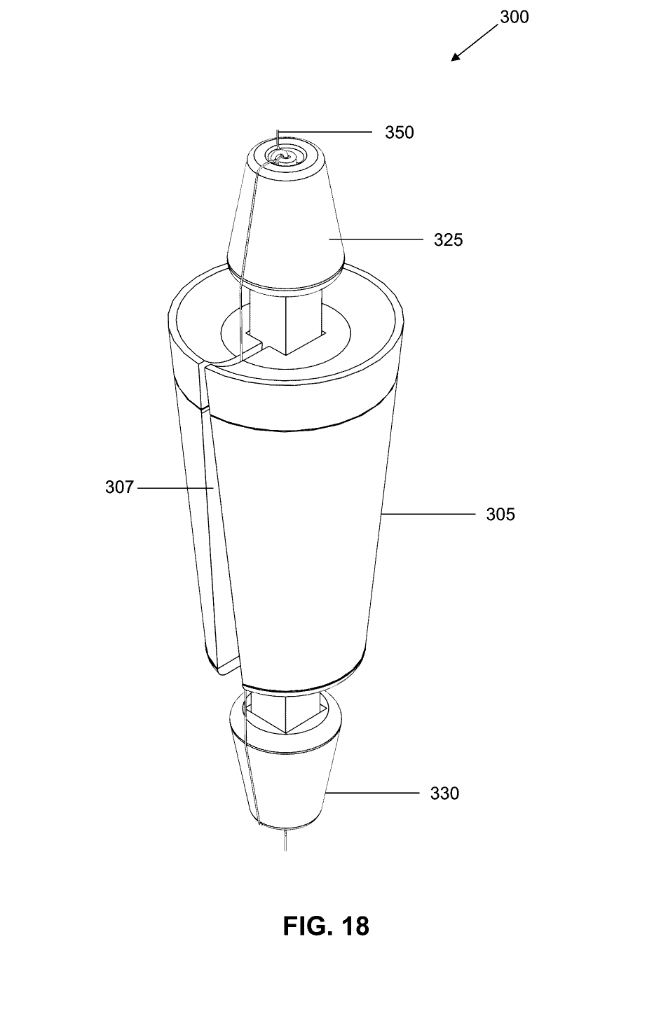

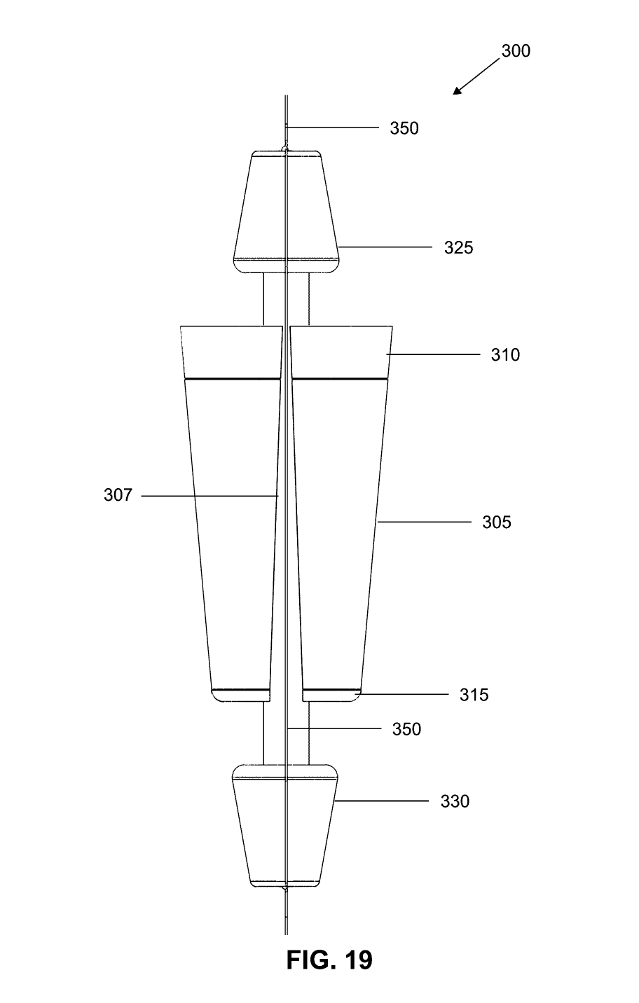

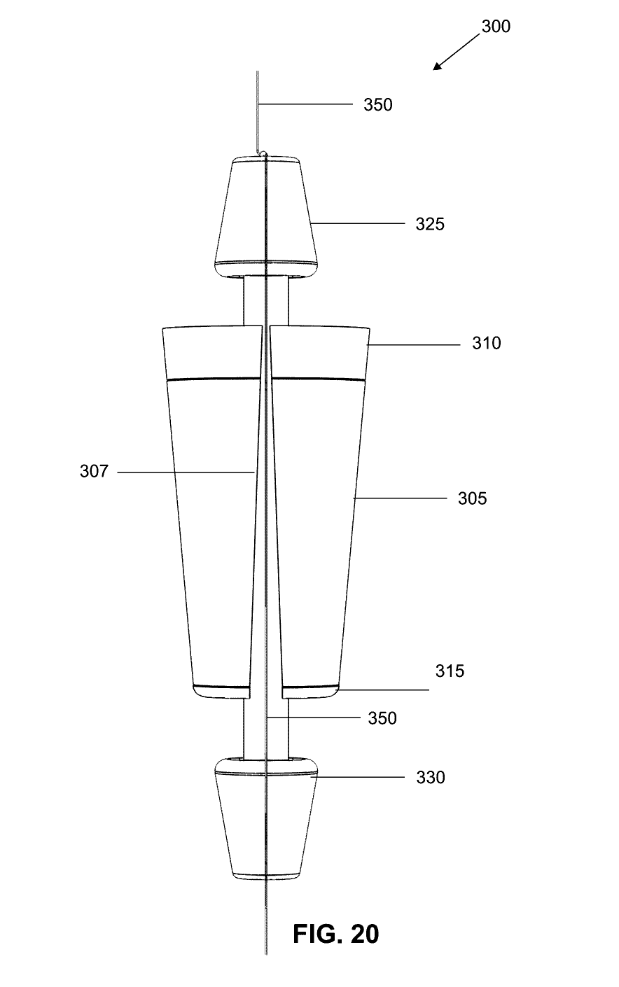

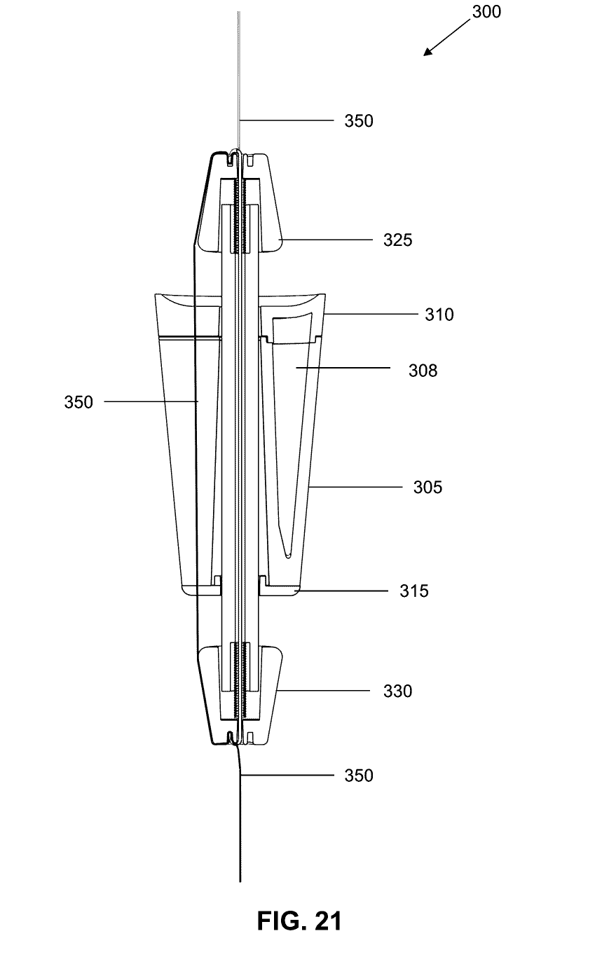

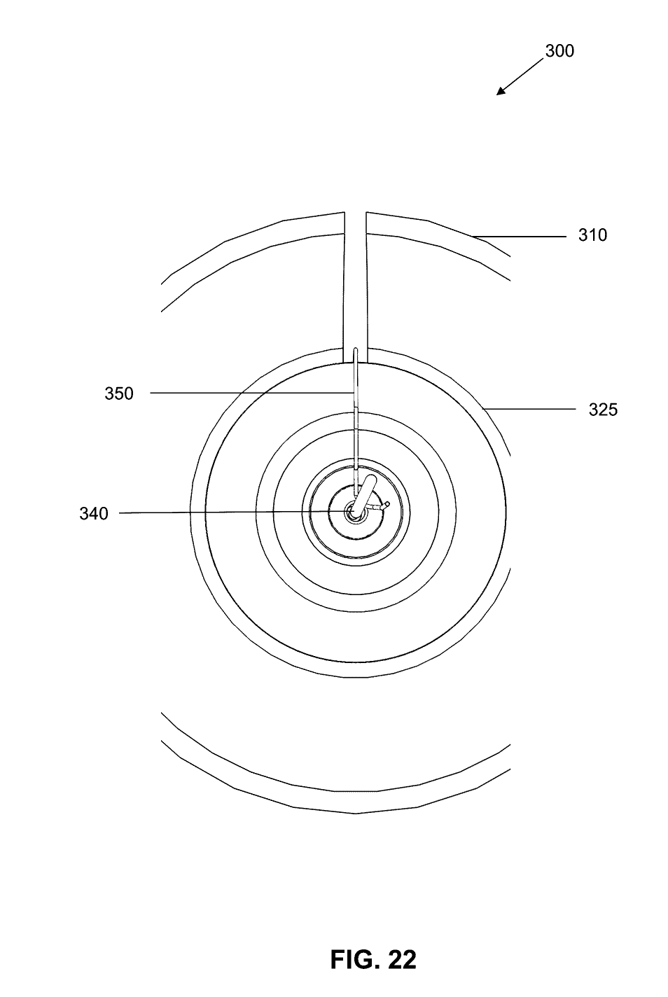

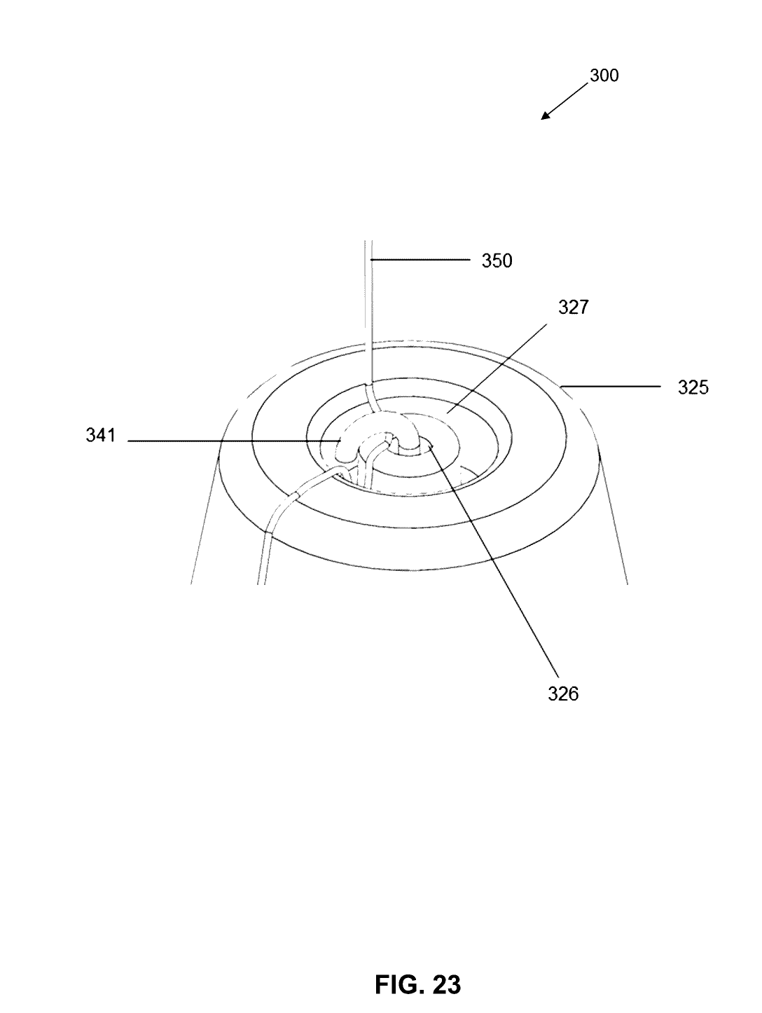

Embodiments of a fishing bobber are disclosed, as shown in FIGS. 1-23. In an initial embodiment, as shown in FIGS. 1-6, a fishing bobber 100 can include a float body 110, a stem 120 and opposing stem caps 130. The stem 120 can extend through the float body 110 and end with opposing stem caps 130. In use, the fishing bobber 100 can sit upright with end 140, or the bottom end 140, in the water pointing substantially down and the opposite end 150, or the top end 150, above the waterline pointing substantially up. The fishing bobber 100 can be releasably clamped to fishing line at each of the opposing stem caps 130, which allows the position of the bobber 100 along the fishing line, and thus the depth of the hook and the bait, to be changed quickly and easily without cutting the line or tying knots.

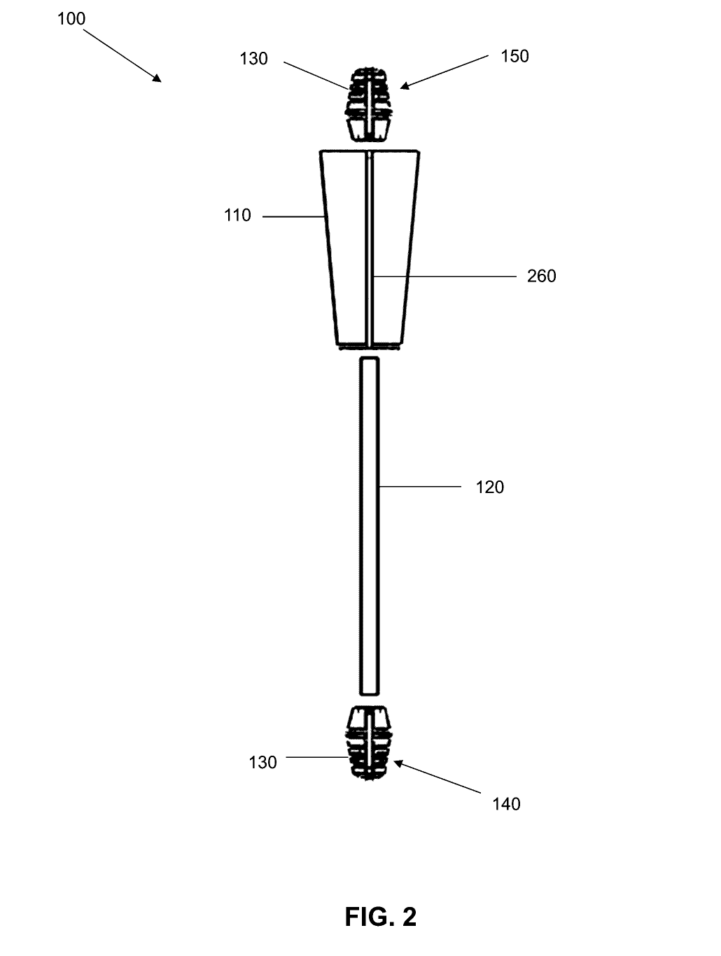

The float body 110 can be arranged freely around the stem 120 and held on the stem 120 between opposing stem caps 130. As shown in FIG. 2, the stem 120 can be inserted into a central bore or cavity of the float body 110. In this arrangement, where the float body 110 is slidably coupled to the stem 120, the float body 110 is free to slide up and down the stem 120 and strike against the opposing stem caps 130. Such free motion of the float body 110 can help attract fish as discussed below.

The float body 110 can provide sufficient buoyancy to float the entirety of the bobber 100, including supporting the hook and bait suspended from the bobber 100. To provide such buoyancy, the float body 110 can have an internal cavity 160 (shown in dashed lines in FIG. 1) with trapped air. Alternatively, or in combination with internal cavity 160, the float body 110 can be made of any material having a specific density less than water, such as foam, to provide additional buoyancy.

The internal cavity 160 can house one or more weights 170, which can be lead weights or other suitable material. The weights 170 can be of a shape matching the shape of internal cavity 160 to provide snug fit. For example, the weights 170 can be u-shaped or an incomplete annulus. In FIG. 1, for example, the weight 170 may have an incomplete annulus shape, a top view of which is shown to the right of the bobber 100 via the dashed lines broken out from the weight 170 placed in the internal cavity 160. As an alternative, the weight utilized with the bobber 100 may have a shape matching the shape of the internal cavity 160, as indicated weight 170′ in FIG. 1. The weights 170 can also be secured in their position, such as by gluing or otherwise attaching the weights to the wall of the internal cavity 160. The weights 170 may be utilized to ensure that the bobber 100 sits correctly in the water with bottom end 140 pointed substantially down and the top end 150 pointed substantially up.

Additionally, the internal cavity 160 of float body 110 can also house one or more rattlers 190. The rattlers 190 can free to move around the internal cavity 160. The rattlers can make a noise and create vibration as they bounce and jumble around the interior of, and bang or clank against the walls of, the internal cavity 160. The noise and vibrations created by the rattlers can help attract fish.

The rattlers can be made of any sufficient materials, such as plastic. In one arrangement, the rattlers can be sphere-shaped and made of lead or other material to provide additional weight to the bobber 100. In another arrangement, the rattlers can be non-uniform, such that rattlers of different size, shape and materials can be combined together in the internal cavity 160. The number and size of the rattlers can vary depending on the intended use.

As shown in FIG. 1, the smaller diameter end of the frusto-conically shaped float body 110 is at the bottom end 140 or submerged end of the bobber 100 when the bobber 100 is in an upright position. In this regard, the frusto-conical shape can be characterized as inverted because the smaller end is the bottom of the frusto-conical shape and larger end is the top of the frusto-conical shape.

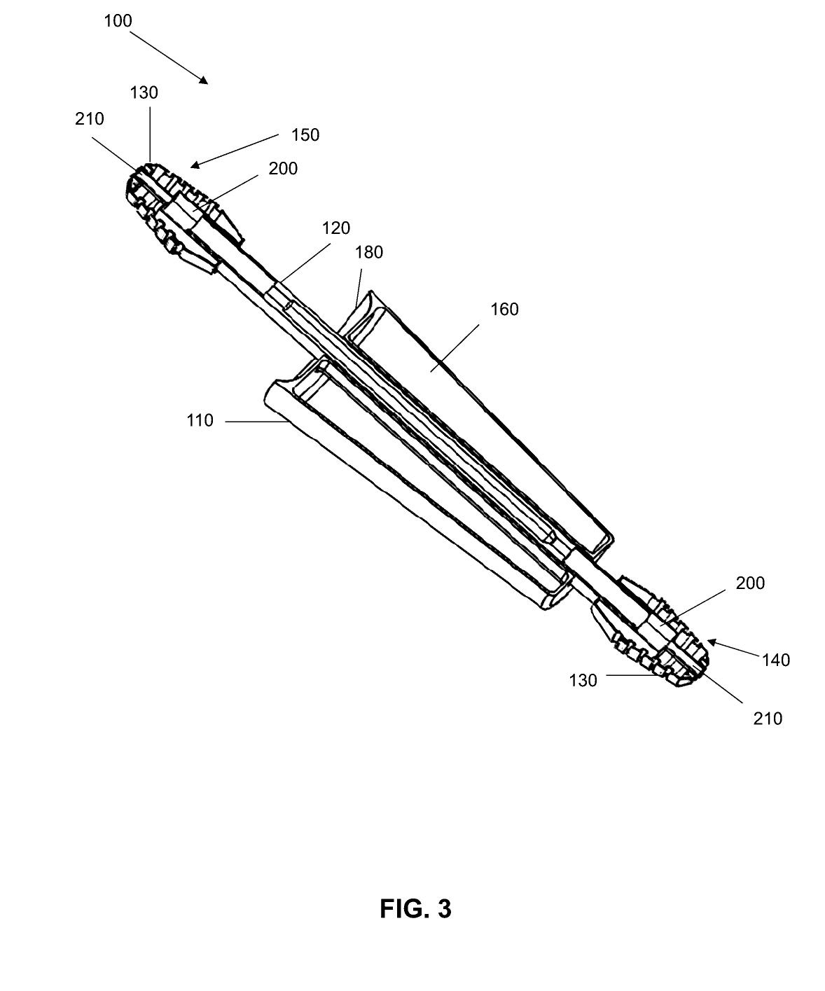

With reference to FIGS. 3 and 6, the float body top 180 can be concave. The float body top 180 can also have a flat bottom surface centrally located in the float body top 180. Because the float body top 180 is concave, water can be displaced into the volume created by the concave top 180. In use, the displaced water can be expelled from, thrown out or splashed out of the concave float body top 180 and back into the water. Such a splash can attract the fish targeted by the fisherman. Also, when a fisherman pulls on the line and the bobber 100, the concave top 180 can produce a leading edge wave that mimics a small bait fish jumping. Notably, the expelling or splashing out of water can occur when pulled by the fisherman or even when the bobber bobs in water, either by fish hitting the bait or live bait repeatedly dragging the bobber 100 down.

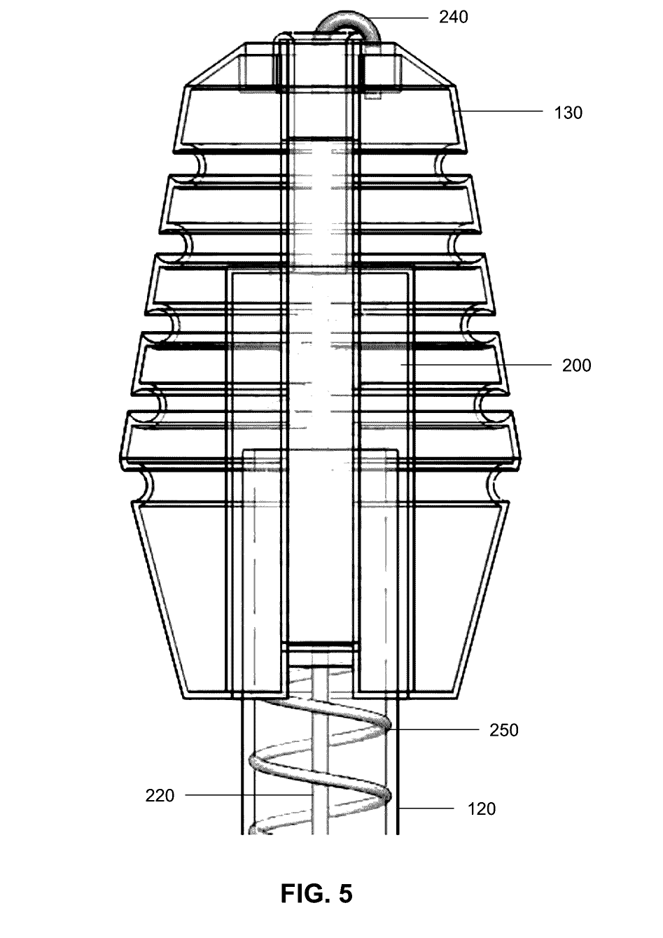

With reference to FIGS. 3 and 5, the opposing stem caps 130 can be located on opposing ends of the stem 120. The opposing stem caps 130 can include circular ridges to assist with a user's grip. The opposing stem caps 130 can have an open ended bore 200, for example an open cylindrical shaped bore. The open ended bore 200 can be coaxial with the stem 120. The open ended internal bore 200 can be shaped and sized to receive a portion of the stem 120. The opposing stem caps 130 can have a second, smaller open ended bore 210. This second, smaller open ended bore 210 can provide a conduit as discussed below.

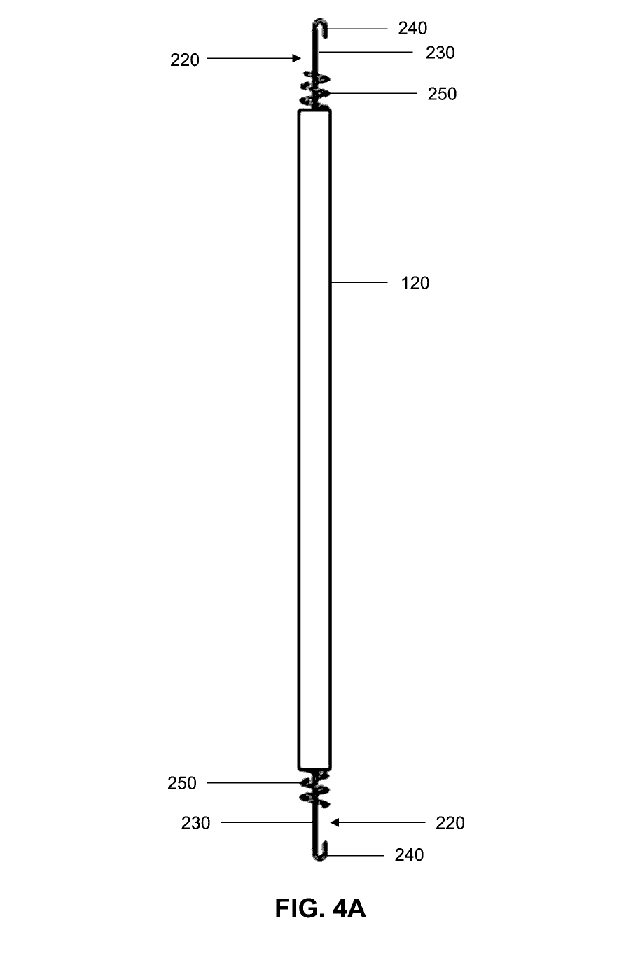

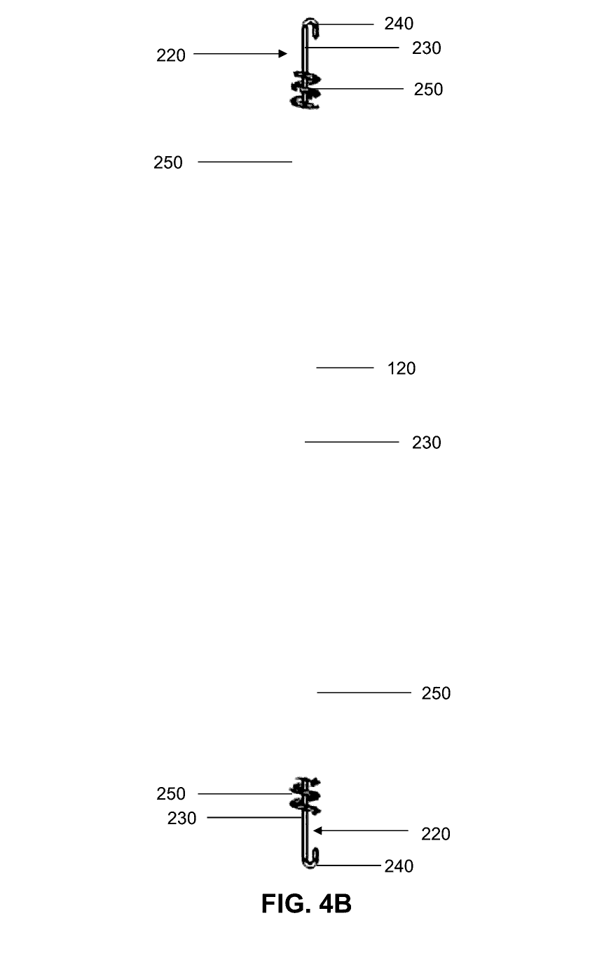

With reference to FIGS. 4A and 4B, a line securing assembly 220, with a line securing rod 230 and opposing hooks 240, can also be provided. The line securing assembly 220, with the line securing rod 230, can extend coaxially with the stem 120 and internally within stem 120. The line securing rod 230 can extend beyond both ends of the stem 120 and terminate with opposing hooks 240. The line securing rod 230 can extend beyond the length of the stem 120 and just beyond the distal ends of the opposing stem caps 130 such that the hooks 240 protrude from the stem caps 130 and hook against and into the opposing stem caps 130.

Biased members, such as springs 250, can be substantially between the stem 120 and the opposing stem caps 130. The springs 250 can be seated in the distal ends of the stem 120 and the open ended bore 200 of each opposing stem caps 130. The springs 250 are biased such they exert a force in the longitudinal direction of the stem 120 against the stem 120 and the respective opposing stem caps 130. At the same time, the force created by the springs 250 pushing the opposing stem caps 130 outward is met by the opposing hooks 240 of securing rod 230 preventing the opposing stem caps 130 from moving away from the stem 120. Such a balance between the biased springs 250 and the opposing hooks 240 is considered the rest position. In alternative arrangements, other biased elements such as bent plastic can be used.

Each of the opposing stem caps 130 and the float body 110 can have a channel 260. As shown in FIG. 1, the channels 260 can be linearly aligned such that they form a contiguous channel of channels 260.

In use, one or both opposing stem caps 130 can be moved against the force of the springs 250 to retract the opposing stem caps 130 along stem 120. Such a retraction will expose the hooks 240 to allow a fishing line to be slipped under one of the hooks 240. The fishing line can be strung along the length of bobber 100 and the process repeated to slip the fishing line under the other hook 240. The fishing line can be strung substantially against the stem 120 by following the channel 260 present in opposing stem caps 130 and float body 110. The channel 260 allows the fishing line to travel parallel to and almost coaxially with the longitudinal axial of the bobber 100 helping keep the bobber 100 orientated with the bottom end 140 down and the top end 150 up, even when fish are biting or the fisherman is reeling in the fishing line.

While fishing, a fisherman can pull or move the rod to create action with the bobber 100. Pull, reeling or jerking the line will pull on the bobber 100. Such force can create two different separate ways to attract the fish. Pulling on the line will pull on the stem cap 130 of the top end 150. As a result, the stem 120 will pulled up, and the bottom stem cap 130 will strike against the float body 110. The striking of the bottom stem cap 130 against the float body 110 will cause rattling of rattlers 190, popping of the bottom stem cap 130 against the float body 110 and water plowing using the float body top 180. The degree and level of the striking action is varied by the force applied based on the type of fish and water conditions. In flat calm water the bobber 100 can be popped gently and in rougher water or windy conditions bobber 100 can be popped more aggressively.

Also, while fishing, a fisherman can contract the opposing stem caps 130 along stem 120 to slip the fishing line under the hooks 240. If the fisherman wants to change the distance between the fishing hook and bobber 100, the fisherman can contract the opposing stem caps 130 along stem 120 and move the line or move the bobber to change the depth of the fishing hook. The distance can be changed whenever desired without the need for cutting the fishing line or tying knots.

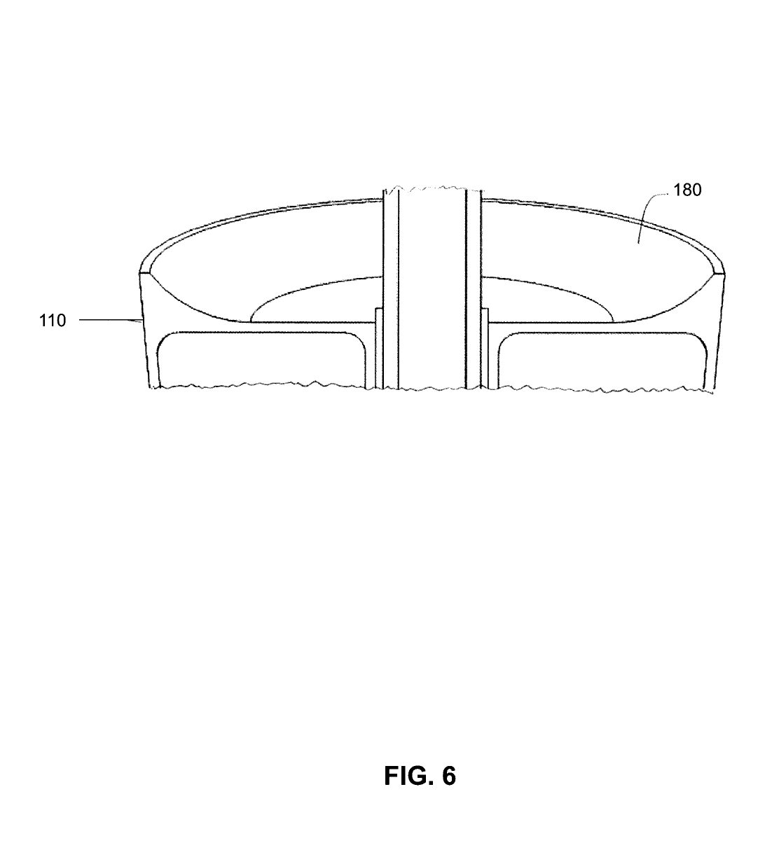

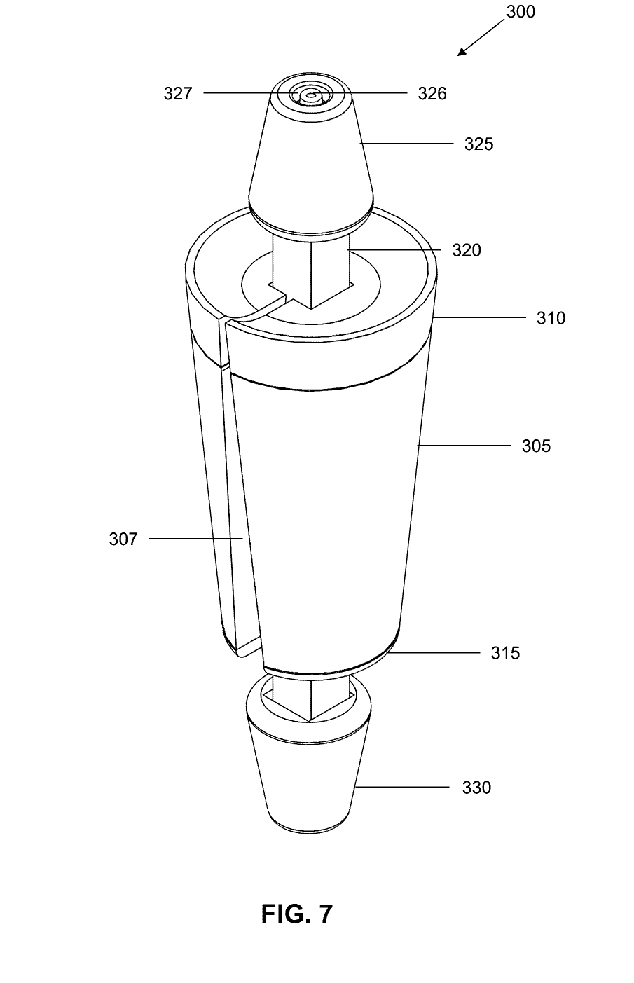

In another embodiment, as shown in FIGS. 7-23, a fishing bobber 300 according to the present disclosure is provided. Notably, in certain embodiments, the fishing bobber 300 may include any of the components, features, and/or functionality used in and/or provided by the fishing bobber 100. In certain embodiments, the fishing bobber 300 may be configured to be attached to fishing line 350. For example, a fisherman using a fishing rod and reel may attach the fishing bobber 300 to a specific position on the fishing line 350 so as to ensure that hooked bait that is attached to the fishing line 350 remains at a desired depth beneath the fishing bobber 300. In certain embodiments, the fisherman may twitch or jerk the fishing rod, pull the fishing line 350, and/or reel in the fishing line 350 at a certain rhythm or pattern, so that the fishing bobber 300 may attract various type of fish. By performing such actions, the fishing bobber 300 may cause a commotion on the body of water that the fishing bobber 300 is floating in. For example, weights 170 and/or rattlers 190 may jostle around inside the fishing bobber 300 as the fisherman is performing such actions so that various sounds are emitted by the fishing bobber 300 into the body of water. Additionally, by performing such actions, water displaced onto a top cap 310 of a float body 305 of the fishing bobber 300 may be thrown out or splashed out via a concave portion 313 of the top cap 310. The splashing out of the water from the top cap 310 may simulate distressed fish, feeding fish, and/or other sounds that may be attractive to various types of fish.

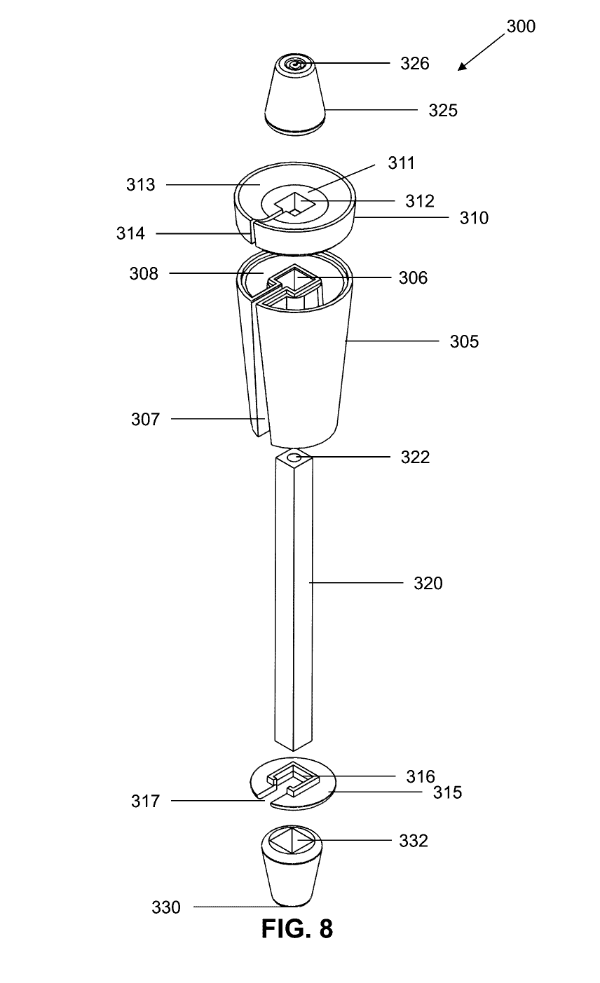

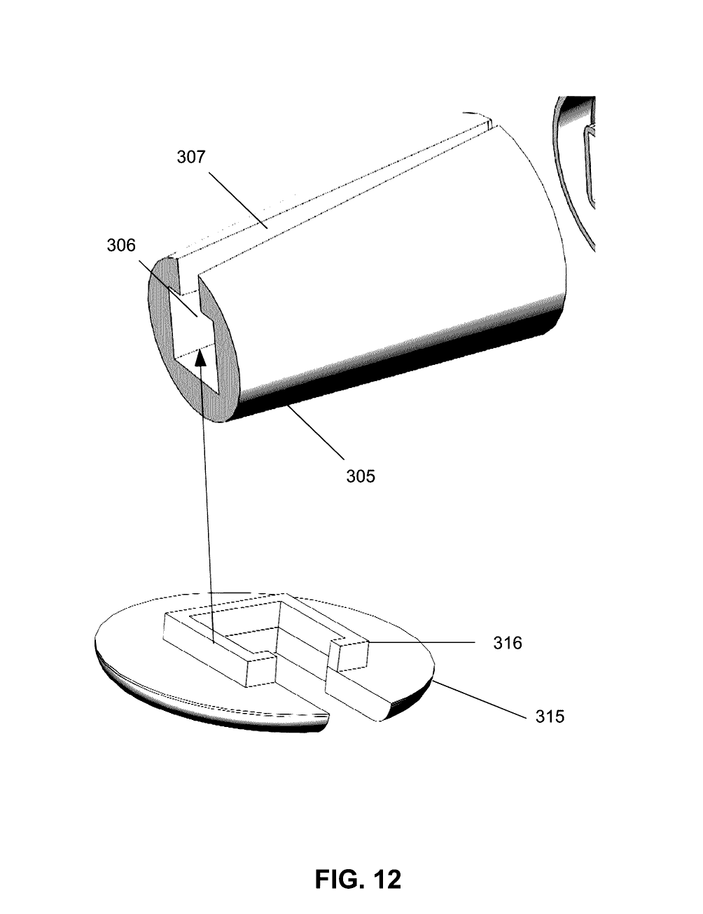

In certain embodiments, the fishing bobber 300 may include a float body 305, a stem 320, and opposing end caps 325, 330. The float body 305 may be made of materials and may have a configuration such that the float body 305 enables the fishing bobber 300 to have sufficient buoyancy to allow the fishing bobber 300 to float in a body of water. In certain embodiments, the materials may include, but are not limited to, balsa wood, plastics, foam materials, reeds, quills, cork material, and/or other materials that may be suitable for allowing the fishing bobber 300 to float in a body of water. In certain embodiments, the float body 305 may have a cylindrical shape, a frusto-conical shape, an inverted frusto-conical shape, a rectangular shape, and/or any other desired shape. The float body 305 may include a central bore 306 that may extend the entire length of the float body 305. In certain embodiments, the central bore 306 may have a rectangular shape shown in FIGS. 8, 10B, 12, and 13. In certain embodiments, the central bore 306 may have a cylindrical shape, may have a shape corresponding to the general shape of the stem 320, or any other desired shape. The float body 305 may also include a channel 307, which may be configured to extend longitudinally along the entire length of the float body 305 and may be configured to house the fishing line 350 when the fishing line 350 is attached to the fishing bobber 300. As shown in FIG. 12, a first end of the channel 307 may be defined by the outer surface of the float body 305 and the second end of the channel 307 may end where the central bore 306 begins.

The float body 305 may also include a cavity 308. The cavity 308 may be configured to have a partially annular or ring-like shape. In certain embodiments, the cavity 308 may be of any suitable shape and size. The cavity 308 may be utilized to house one or more weights 170, which may be made of lead, steel, plastic, and/or any other suitable material. In certain embodiments, the weights 170 may have a shape that is similar to the cavity 308. For example, the weights 170 may have a partially annular shape, cylindrical shape, or other desired shape. In certain embodiments, the weights 170 may freely reside in the cavity 308, however, in other embodiments, the weights 170 may be physically secured to the walls defining the cavity 308. Additionally, the cavity 308 may be utilized to house one or more rattlers 190. The rattlers 190 may be configured to move freely in the cavity 308 so that when the fisherman pulls the fishing line 350 and/or jerks the fishing rod, the rattlers 190 will jostle around inside the cavity 308. The jostling action of the rattlers 190 may create noise and vibrations that may attract fish to the fishing bobber 300 and/or to bait suspended by the fishing bobber 300.

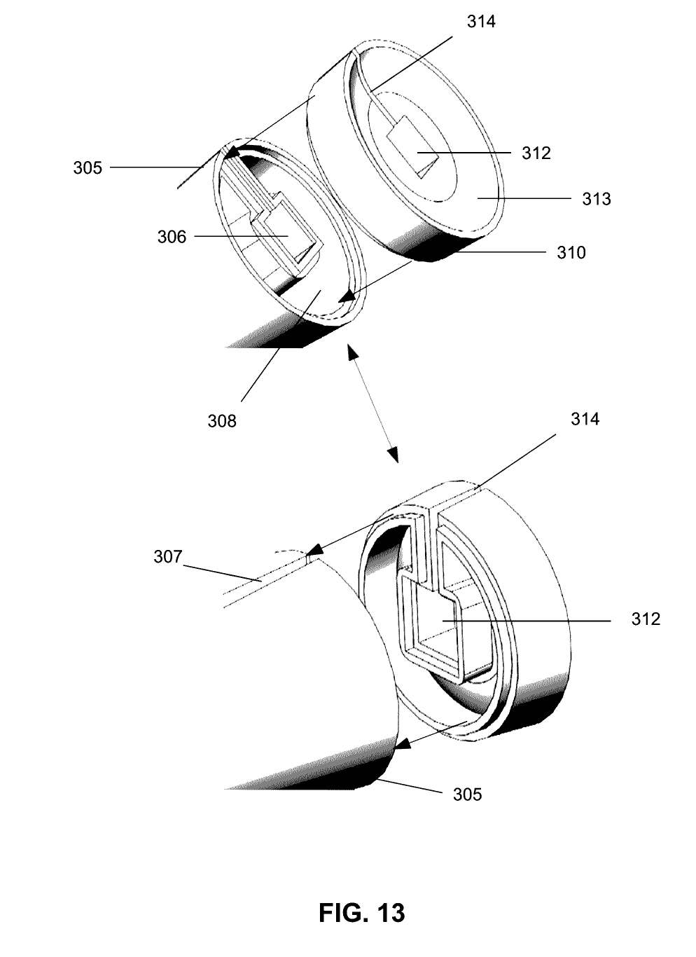

The float body 305 may include a top cap 310 and a bottom cap 315. The top cap 310 may be affixed to the top end of the float body 305. The top cap 310 may be affixed to the float body 305 via an interference fit, via clasps, via interlocking grooves, and/or via any other affixing means. In the Figures, the top cap 310 fits into the float body 305 via grooves. In certain embodiments, the top cap 310 may include a central top cap bore 312, which may have a width and shape such that the central top cap bore 312 may align with the central bore 306 of the float body 305 when the top cap 310 is affixed to the top of the float body 305. FIG. 13 illustrates the top cap 310 being affixed to the float body 305. A portion of the stem 320, which is discussed in further detail below, may be configured to be inserted through the central bore 306 and through the central top cap bore 312. The top cap 310 may also include a concave portion 313 located on the top side of the top cap 310, and a generally flat portion 311 located where the concave portion 313 ends. When the fishing bobber 300 is placed in water, an amount of water may be displaced from the water surrounding the fishing bobber 300 into the volume created by the concave portion 313 and the flat portion 311. The water may be displaced into the volume in response to the fisherman pulling on the fishing line 350 and/or based on waves hitting the fishing bobber 300. As the fishing bobber 300 jostles around, the amount of water that is displaced into the volume may then splash out and/or be thrown out from the volume and back into the water surrounding the fishing bobber 300. The splashing generated by the fishing bobber 300 may be utilized to attract fish into thinking that a distressed fish is in the vicinity of the fishing bobber 300. In certain embodiments, when the fisherman pulls on the fishing line 350 or reels in the fishing line 350, the concave portion 313 of the top cap 310 may cause a leading edge wave to be formed that may simulate a small bait fish jumping. The top cap 310 may also include a channel 314, which may be configured to align with the channel 307 when the top cap 310 is affixed to the float body 305.

In addition to including the top cap 310, the float body may also include a bottom cap 315. The bottom cap 315 may be utilized to reduce any unwanted movements by the stem 320. The bottom cap 315 may be affixed to the bottom end of the float body 305, and may be affixed to the float body 305 via an interference fit, via clasps, via interlocking grooves, and/or via any other affixing means. Much like the top cap 310, the bottom cap 315 may include a central bottom cap bore/opening 316, which may have a width and shape such that the central bottom cap bore 316 may align with the central bore 306 of the float body 305 when the bottom cap 315 is affixed to the bottom of the float body 305. FIG. 12 illustrates the bottom cap 315 and how it affixes to the bottom of the float body 305. A portion of the stem 320, which is discussed in further detail below, may be configured to be inserted through central bottom cap bore 316 and the central bore 306 of the float body 305. The bottom cap 315 may also include a channel 317, which may be configured to align with the channel 307 and the channel 314 when the bottom cap 315 is affixed to the float body 305.

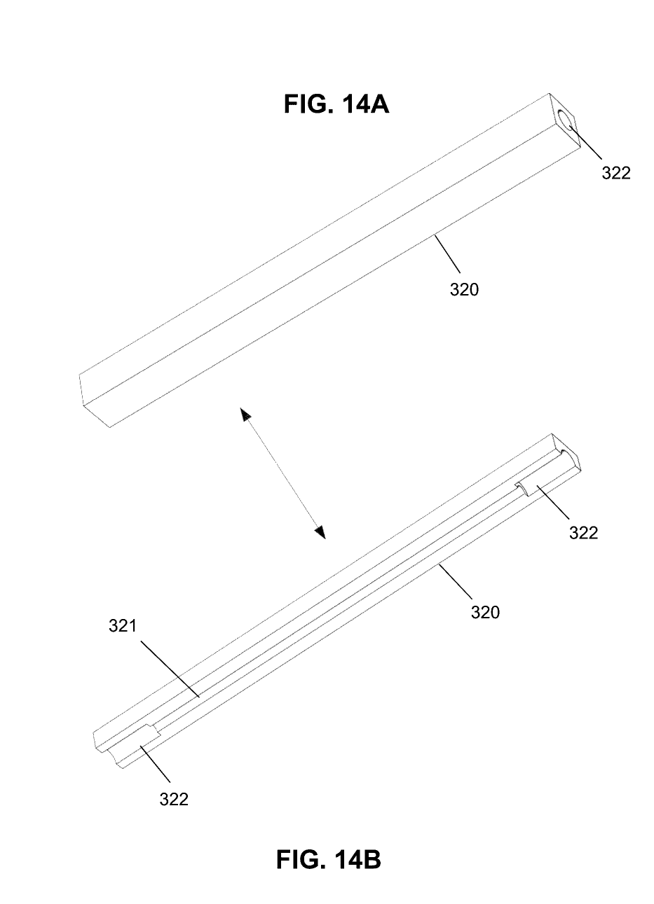

In addition to including the float body 305, the top cap 310, and the bottom cap 315, the fishing bobber 300 may also include a stem/shaft 320, as shown in at least FIGS. 14A and 14B. The stem 320 may be utilized to provide support for various components of the fishing bobber 300 and may be configured to act as a mechanism to connect the various components of the fishing bobber 300 together. Additionally, the stem 320 may allow the float body 305 to travel up and down the stem 320, as well as housing the line securing assembly 340 and springs 345, which are discussed in further detail below. The stem 320 may extend through bottom cap 315, the float body 305, the top cap 310, and through portions of the top and bottom stem caps 325, 330. In certain embodiments, the bottom cap 315, the float body 305, the top cap 310, and the top and bottom stem caps 325, 330 may be slidably coupled to the stem 320. In certain embodiments, the float body 305 may be free to slide up and down the stem 320 and strike against the top and bottom stem caps 325, 330. Such striking action may attract fish via vibrations and sounds caused by the striking action. The stem 320 may have any desirable shape, and, is schematically illustrated as have a generally rectangular shape in the Figures. The stem 320 may include top and bottom stem bores 322, which may extend within the stem 320 for a predetermined distance. In certain embodiments, the top and bottom stem bores 322 may have a cylindrical shape, a rectangular shape, or any other desired shape. Illustratively, FIGS. 7-23 depict the top and bottom stem bores 322 as having a cylindrical shape. The top and bottom stem bores 322 may be configured to house a portion of the springs 345 of the fishing bobber 300.

The stem 320 may also include a central stem bore 321, which may reside between the top and bottom stem bores 322. In certain embodiments, the central stem bore 321 may be configured to have a smaller width than the top and bottom stem bores 322. In the certain embodiments the central stem bore 321 may have a cylindrical shape, a rectangular shape, or any other desired shape. Illustratively, FIGS. 7-23 depict the central stem bore 321 as having a cylindrical shape. The central stem bore 321 may be configured to house line securing assembly 340, which may have a top hook 341 and a bottom hook 342. In particular, the line securing assembly 340 may extend coaxially with the stem 320 and internally within the central stem bore 321 of the stem 320. The line securing assembly 340 may be utilized to secure the fishing line 350 to the fishing bobber 300 and also to prevent the top and bottom stem caps 325, 330 from detaching from the fishing bobber 300. The distal ends of the line securing assembly 340 are configured to extend beyond both ends of the stem 320 and the ends of the top and bottom stem caps 325, 330 such that the top and bottom hooks 341, 342 protrude from the top and bottom stem caps 325, 330 respectively and hook against and into the top and bottom stem caps 325, 330.

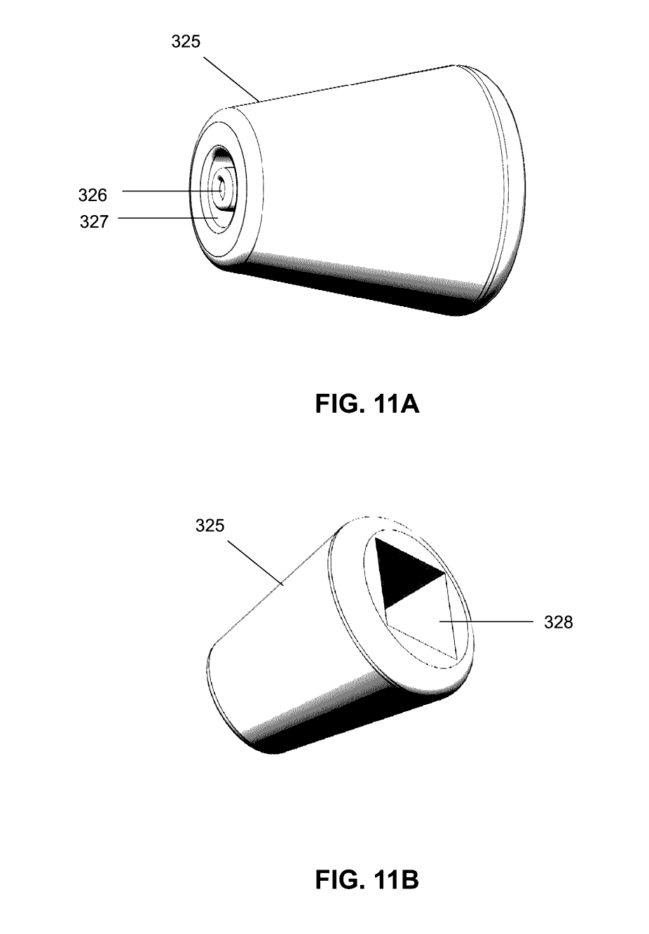

The top stem cap 325 of the fishing bobber 300 may be positioned on the top end of the stem 320, and the bottom stem cap 330 may be positioned on the bottom end of the stem 320. The top stem cap 325 may include an open ended bore 328 that may have a size and shape to receive a portion of the top end of the stem 320. In FIG. 11B, for example, the open ended bore 328 is shown as having a rectangular-shaped opening configured to receive the rectangular-shaped stem 320. The open ended bore 328 may extend partially through the body of the top stem cap 325, and is shown in the Figures as extending beyond half the length of the top stem cap 325. The top stem cap 325 may also include another smaller open ended bore 326 located at the top end of the top stem cap 325. In certain embodiments, the open ended bore 326 may have a smaller width than the open ended bore 328. The top hook 341 of the line securing assembly 340 may be configured to protrude out of the open ended bore 326 and latch onto a groove 327 of the top stem cap 325 when the fishing bobber 300 is in its resting/relaxed position. In certain embodiments, the groove 327 may be a ring-shaped or annular grove that resides within the top end of the top stem cap 325, as shown in the Figures.

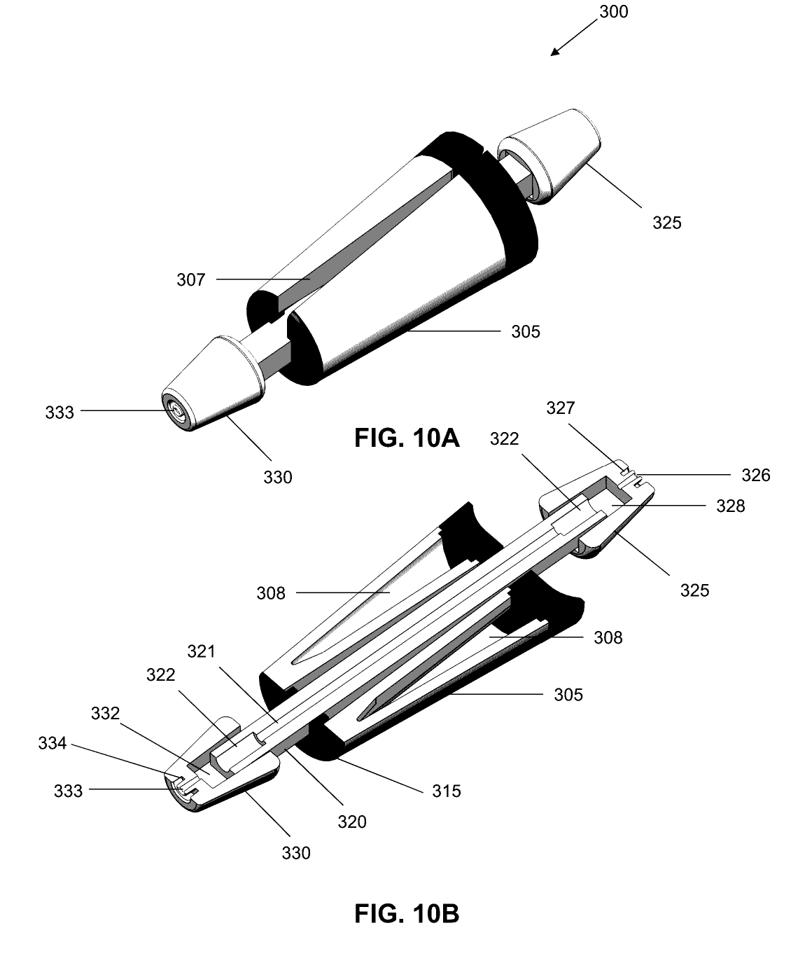

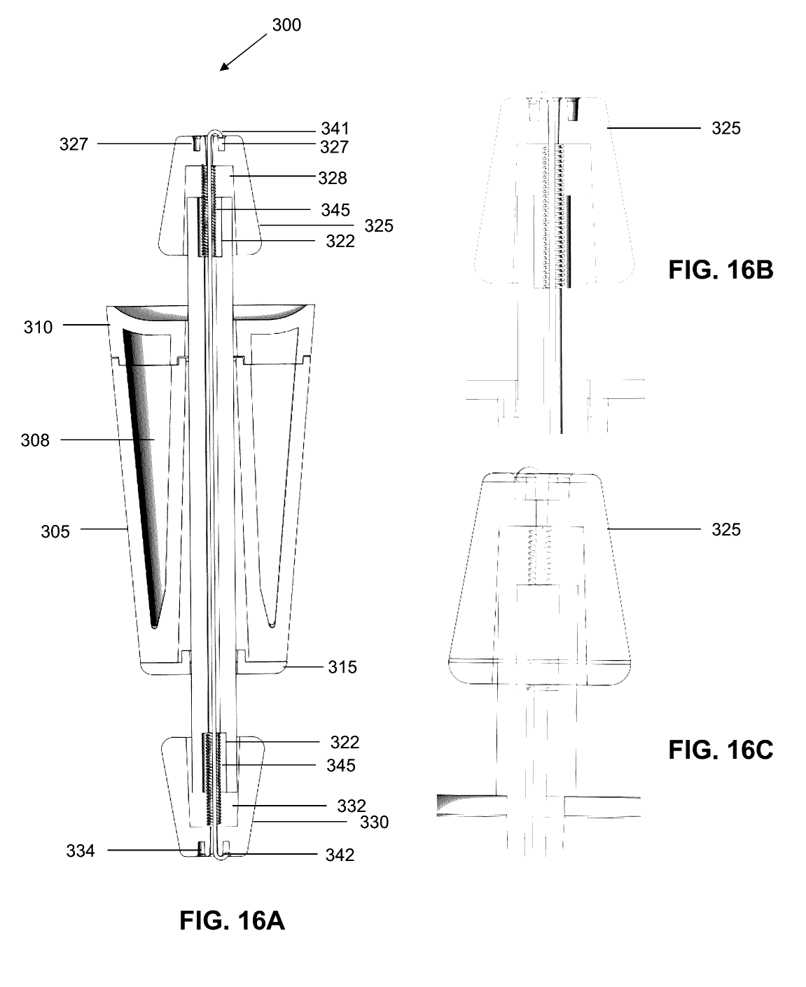

The bottom stem cap 330 of the fishing bobber 300 may include similar components and features as the top stem cap 325, but may be positioned at the bottom end of the stem 320. The bottom stem cap 330 may include an open ended bore 332 that may have a size and shape to receive a portion of the bottom end of the stem 320. In FIG. 10B, for example, the open ended bore 332 is shown as having a rectangular-shaped opening configured to receive the rectangular-shaped bottom end of the stem 320. The open ended bore 332 may extend partially through the body of the bottom stem cap 330, and is shown in the Figures as extending beyond half the length of the bottom stem cap 330. The bottom stem cap 330 may also include another smaller open ended bore 333 located at the bottom end of the bottom stem cap 330. In certain embodiments, the open ended bore 333 may have a smaller width than the open ended bore 332. The bottom hook 342 of the line securing assembly 340 may be configured to protrude out of the open ended bore 333 and latch onto a groove 334 of the bottom stem cap 330 when the fishing bobber 300 is in its resting/relaxed position, as shown in FIGS. 16A-23. In certain embodiments, the groove 334 may be a ring-shaped or annular grove that resides within the bottom end of the bottom stem cap 330, as shown in the Figures.

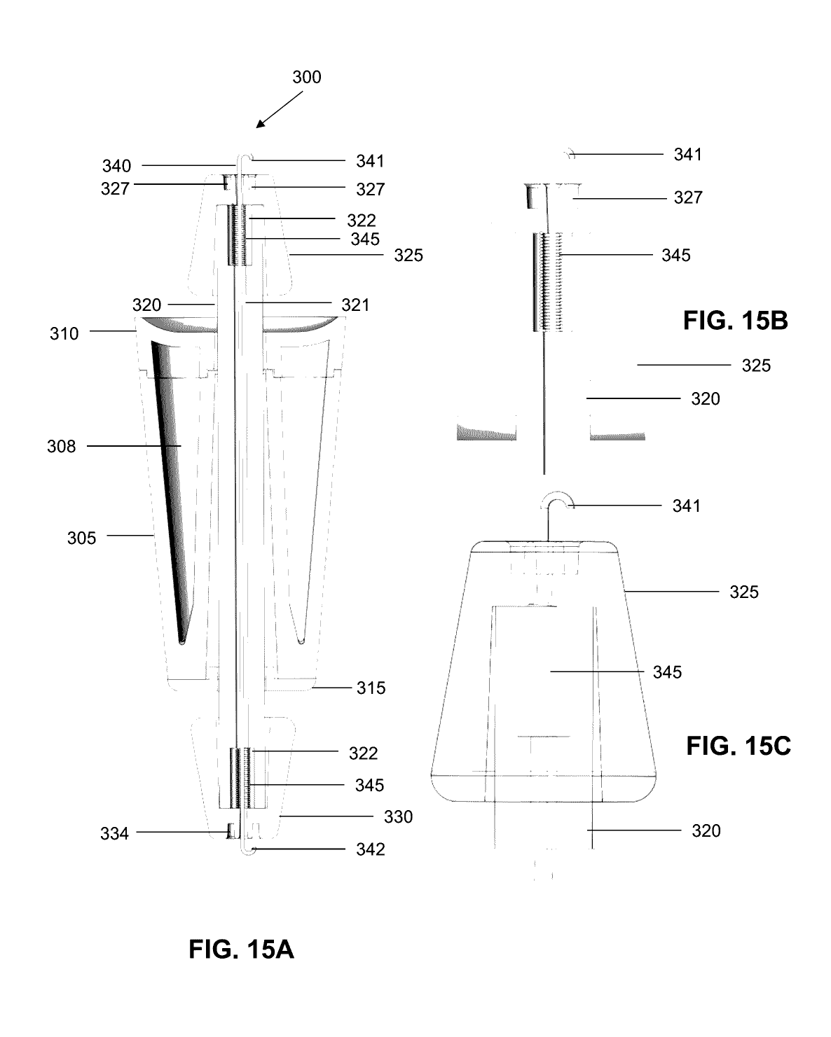

The fishing bobber 300 may also include at least two springs 345, one of which may reside substantially between the stem 320 and the top stem cap 325, and the other of which may reside substantially between the stem 320 and the bottom stem cap 330. In particular, a portion of a first spring 345 may reside within the top stem bore 322 and another portion of the first spring 345 may reside within the open ended bore 328 of the top stem cap 325. Similarly, a portion of a second spring 345 may reside within the bottom stem bore 322 and another portion of the second spring 345 may reside within the open ended bore 332 of the bottom stem cap 330. The springs 345 may be biased such they exert a force in the longitudinal direction of the stem 320 against the stem 320 and the respective top and bottom stem caps 325, 330. At the same time, the force created by the springs 345 pushing the top and bottom stem caps 325, 330 outward is met by the top and bottom hooks 341, 342 of the line securing assembly 340 thereby preventing the top and bottom stem caps 325, 330 from moving away from the stem 320. Such a balance between the biased springs 345 and the top and bottom hooks 341, 342 may be considered the resting position, as described above. If a fisherman exerts pressure down on the top stem cap 325 and/or pressure up against the bottom stem cap 330, the springs 345 may contract/retract and cause the top and bottom hooks 341, 342 to be exposed, as shown in FIGS. 15A-15C.

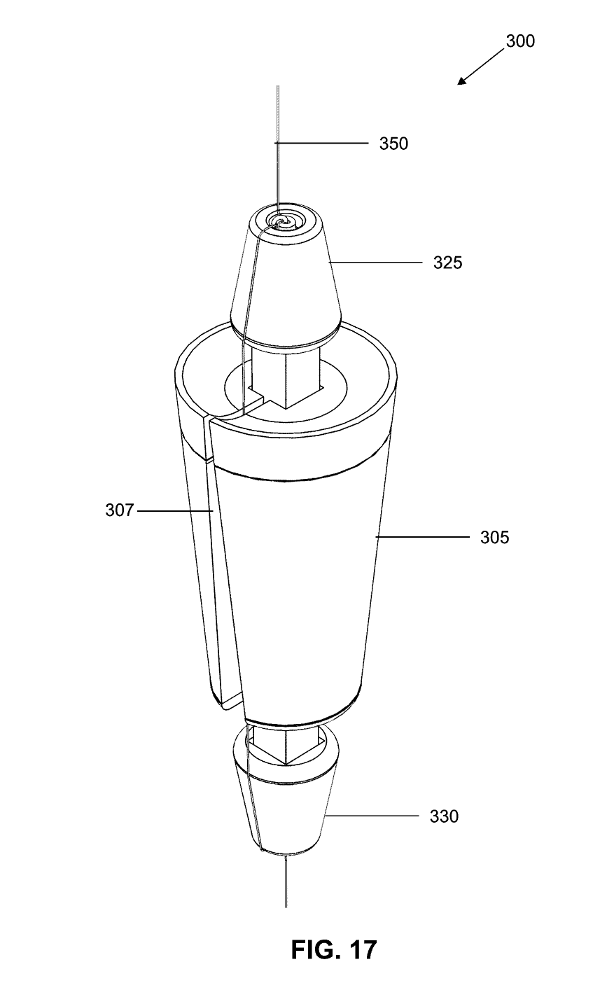

In operation, a fisherman can move one or both of the top and bottom stem caps 325, 330 against the force of the springs 345 to retract the top and bottom stem caps 325, 330 along stem 320. Such a retraction may expose the top and bottom hooks 341, 342 to enable the fishing line 350 to be slipped under each of the hooks 341, 342, as shown in FIGS. 17-23. In this way, the fishing line 350 may be secured to the fishing bobber 300. The fishing line 350 can be strung substantially in proximity to the stem 320 by following the fishing line 350 through the channel 307 of float body 305 and through the channels 314 and 317 of the top and bottom caps 310, 315 respectively. The channels 307, 314, 317 allow the fishing line 350 to travel parallel to and almost coaxially with the longitudinal axis of the fishing bobber 300. This assists in keeping the fishing bobber 300 orientated with the bottom end down and the top end up, even when fish are biting hooked bait or the fisherman is reeling in the fishing line.

While a fisherman is fishing with the fishing bobber 300, the fisherman can pull, jerk, or move the rod to create action with the fishing bobber 300. Pull, reeling or jerking the fishing line 350 will pull on the fishing bobber 300. As indicated in this disclosure, such a force generated by such actions may facilitate different ways to attract the fish. Pulling on the fishing line 350 will pull on the top stem cap 325. As a result, the stem 320 may be pulled up, and the bottom stem cap 330 may strike against the float body 305. The striking of the bottom stem cap 330 against the float body 305 may cause rattling of rattlers 190, popping of the bottom stem cap 330 against the float body 305 and water plowing using the concave portion 313 of the top cap 310. The degree and level of the striking action may be varied by the force applied based on the type of fish and water conditions. In flat calm water, the fishing bobber 300 may be popped gently, and, in rougher water or windy conditions, the fishing bobber 300 may be popped more aggressively.

Also, while fishing, a fisherman can contract the top and bottom stem caps 325, 330 along the stem 320 to slip the fishing line 350 under the top and bottom hooks 341, 342 to secure the fishing line 350 at a certain desired position on the fishing line 350. However, if the fisherman wants to change the distance between the fishing hook and bobber 100, the fisherman can contract the top and bottom stem caps 325, 330 along stem 320 and move the line or move the fishing bobber 300 to change the length of the fishing line 350 suspended beneath the bottom end of the fishing bobber 300. Notably, the length of the fishing line 350 suspended beneath the bottom end of the fishing bobber 300 can be changed whenever desired without the need for cutting the fishing line or tying knots. Notably, in certain embodiments, the fishing bobber 300 may include any of the components, features, and/or functionality used in and/or provided by the fishing bobber 100. For example, the top and bottom stem caps 325, 330 may include channels as found in opposing stem caps 130 of the fishing bobber 100.

In certain embodiments, the fishing bobber 100 and 300 may be made of a plastic, metal, or a combination of plastic and metal. In certain embodiments, the top and bottom stem caps 325, 330, the stem 320, the float body 305, the top cap 310, and the bottom cap 315 may be made of plastic. In certain embodiments, the line securing assembly 340 and the springs 345 may be made of metal. In certain embodiments, the total length of the fishing bobber 100 and/or 300 may vary based on the contraction or expansion of the springs. For example, in an uncompressed state, the fishing bobber 300 may have a length of 6 inches, in a preferred embodiment. In the same embodiment, the fishing bobber 300 may have a length of 5.5 inches when the springs are in a compressed state. In certain embodiments, the stem 320 and the bore 322 may be designed to have a hyperrectangular form to prevent rolling, which may tangle the fisherman's fishing line 350.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A fishing bobber, comprising:
a float body having an internal cavity with a weight and a rattler, wherein the float body includes a concave top that expels out displaced water to create a splash;
a stem extending through the float body and terminating at a first end and a second end, wherein the first end includes a first biased member and the second end includes a second biased member;
a line securing rod with opposing hooks extending coaxial with the stem and beyond the first biased member and the second biased member; and
opposing stem caps, wherein each stem cap includes a central bore through which an opposing hook of the line securing rod extends.

2. The fishing bobber of claim 1, wherein the opposing stem caps and the float body each have a channel for receiving a fishing line and the channel of the opposing stem caps and the channel of the float body are linearly aligned.

3. The fishing bobber of claim 1, wherein the float body is inverted frusto-conical.

4. The fishing bobber of claim 1, wherein the first biased member and second biased member are springs.

5. The fishing bobber of claim 1, wherein the weight has a shape that matches the internal cavity shape.

6. The fishing bobber of claim 1, wherein a shape of the weight comprises an incomplete annulus.

7. The fishing bobber of claim 1, wherein the opposing hooks can be releasably clamped to a fishing line at each of the opposing stem caps, whereby the position of the bobber along the fishing line is adjustable without cutting the fishing line or tying knots.

8. The fishing bobber of claim 1, wherein the first biased member and second biased member are individually seated between the stem and the opposing stem caps.

9. The fishing bobber of claim 1, wherein the float body is slidably coupled to the stem and free to slide along a length of the stem to strike against the opposing stem caps.

10. A fishing bobber, comprising:
a float body having an internal cavity with a weight and a rattler, wherein the float body includes a concave top that expels out displaced water to create a splash;
a stem extending through the float body and terminating at a first end and a second end, wherein the first end includes a first biased member and the second end includes a second biased member, wherein the first biased member and second biased member are individually seated between the stem and opposing stem caps, and wherein the first biased member and second biased member are springs;
a line securing rod with opposing hooks extending coaxial with the stem and beyond the first biased member and the second biased member;
the opposing stem caps, wherein each opposing stem cap includes a central bore through which an opposing hook of the line securing rod extends; and
wherein the float body is slidably coupled to the stem and free to slide along a length of the stem so as to strike against the opposing stem caps.

11. The fishing bobber of claim 10, wherein the float body is frusto-conical.

12. The fishing bobber of claim 10, wherein the opposing stem caps and the float body each have a channel for receiving a fishing line and the channel of the opposing stem caps and the channel of the float body are linearly aligned.

13. The fishing bobber of claim 10, wherein the weight has a shape that matches the internal cavity shape.

14. The fishing bobber of claim 10, wherein a shape of the weight comprises an incomplete annulus.

15. A fishing bobber, comprising:
a float body having an internal cavity with a weight and a rattler, wherein the float body includes a concave top that expels out displaced water to create a splash and wherein the float body is frusto-conical;
a stem extending through the float body and terminating at a first end and a second end, wherein the first end includes a first biased member and the second end includes a second biased member, wherein the first biased member and second biased member are individually seated between the stem and opposing stem caps, and wherein the first biased member and second biased member are springs;
a line securing rod with opposing hooks extending coaxial with the stem and beyond the first biased member and the second biased member; and
the opposing stem caps, wherein each stem cap includes a central bore through which an opposing hook of the line securing rod extends.

16. The fishing bobber of claim 15, wherein the opposing hooks can be releasably clamped to a fishing line at each of the opposing stem caps, whereby the position of the bobber along the fishing line is adjustable without cutting the fishing line or tying knots.

17. The fishing bobber of claim 15, wherein the weight has a shape that matches the internal cavity shape.

18. The fishing bobber of claim 15, wherein a shape of the weight comprises an incomplete annulus.

19. The fishing bobber of claim 15, wherein the float body comprises a top cap and a bottom cap.

20. The fishing bobber of claim 15, wherein portions of the opposing stem caps and the stem create chambers which house the first and second biased members.
